(19) United States
(12) Patent Application Publication
(10) Pub. No.: US 2015/0134404 A1
(43) Pub. Date: May 14, 2015

(54) WEIGHTED PROMOTER SCORE ANALYTICS SYSTEM AND METHODS

(71) Applicant: Mattersight Corporation, Chicago, IL (US)

(72) Inventors: David GUSTAFSON, Lake Bluff, IL (US); Christopher Danson, Austin, TX (US); Tomasz Stadnik, Chicago, IL (US); Jessica Leigh Hempel, Chicago, IL (US); Rachel Jean Stark, Berwyn, IL (US); Alain Stephan, Glenview, IL (US)

(21) Appl. No.: 14/078,184

(22) Filed: Nov. 12, 2013

(51) Int. Cl. G06Q 30/02

(52) U.S. Cl. CPC G06Q 30/0201
USPC 705/7.29

(57) ABSTRACT

The methods, apparatus, and systems described herein provide weighted promoter scores (WPS) for customers that have increased precision and/or accuracy compared to a traditional NPS®. The methods include receiving a communication between an agent and a customer, extracting a data attribute from the communication including personality type of the customer, inputting the personality type into an algorithm trained to output a WPS, and outputting a WPS for the customer.

### TECHNICAL FIELD

The present disclosure generally relates to methods, apparatus, and systems that provide a more accurate and/or precise Net Promoter Score^{SM} (NPS®) of a customer by extracting data attributes, such as personality type or call interaction data, from a customer communication.

### BACKGROUND OF THE DISCLOSURE

Customer service management traditionally includes conducting a service call between a customer and a customer service agent and recording information about the interaction after it ends. The step of recording performance of a customer service representative is most often carried out by the customer service agent personally through self-reporting. Other times, a customer is asked to fill out a survey relating to the call subsequent to the interaction. In the vast majority of cases, the survey asks the customer to comment on a variety of topics. This approach typically does not involve all of the information that is important to an individual customer, and returns little information and oftentimes no useful information. Moreover, customers typically do not want to spend the time to respond to a survey, unless they had a particularly good or bad experience.

The Net Promoter Score^{SM} (NPS®) is a customer loyalty metric developed by Fred Reichhelds, Bain & Company and Satmetrix. The NPS® is a convenient and simple way to measure customer satisfaction. Customers rate their satisfaction on a scale of 0 to 10 about a company, service, or a product they use. The results are used to divide customers into three groups: Promoters, Passives, and Detractors. Promoters provide a score of 9-10, Passives provide a score of 7-8, and Detractors provide a score of 1-7. The percentage of Detractors is then subtracted from the percentage of Promoters to obtain the NPS®.

The NPS® system typically does not provide accurate data because of low response rates and personality bias, which can lead to faulty results. The low survey response rate can hamper use of the NPS® for individual customer treatment, as well as for individual customer contact agent coaching. Generally, there are not enough NPS® survey responses to address all unsatisfied customers, or to target training to any customer service agents. If these results are used to prevent customer attrition, the company using the scores may end up spending a lot of time and effort trying to increase customer satisfaction in ways that will not directly target the needs of customers. Accordingly, improved methods and systems are needed.

### SUMMARY

The present disclosure seeks to improve the accuracy of the NPS® to help correct for under reporting in the data, and to provide actionable data at the customer and customer contact agent levels. The present methods extract information from a customer communication and use it to calculate a weighted promoter score, which is a more accurate type of NPS®, or alternatively, may be obtained through prediction even if a customer has not completed an NPS® survey.

In one aspect, the present disclosure relates to a system for providing a weighted promoter score (WPS). The system includes a node that includes a processor and a non-transitory computer readable medium operably coupled thereto, and the non-transitory computer readable medium includes a plurality of instructions stored in association therewith that are accessible to, and executable by, the processor. The plurality of instructions include instructions that, when executed, receive a communication between an agent and a customer; instructions that, when executed, determine personality type of the customer; and instructions that, when executed, output an WPS of the customer based on the personality type.

In a second aspect, the present disclosure relates to a method for providing a weighted promoter score (WPS). The method includes receiving a communication between an agent and a customer; extracting a data attribute from the communication, including personality type of the customer; inputting the personality type into an algorithm trained to output a WPS; and outputting an WPS for the customer.

In a third aspect, the present disclosure relates to a computer readable medium that includes a plurality of instructions. The plurality of instructions include instructions that, when executed, receive a communication between an agent and a customer; instructions that, when executed, retrieve or predict personality type of the customer; instructions that, when executed, extract a data attribute from the communication; and instructions that, when executed, output an WPS of the customer based on the personality type and other data attributes of the communication.

In a fourth aspect, the present disclosure relates to an apparatus for providing a weighted promoter score (WPS) that includes a database module adapted to receive a communication between an agent and a customer and determine a personality type of the customer; and a scoring module adapted to use the determination to output an WPS of the customer.

In a fifth aspect, the present disclosure relates to a method for providing a weighted promoter score (WPS) of a customer. The method includes recording a telephonic interaction between an agent and a customer, extracting a plurality of data attributes from the telephonic interaction, inputting a plurality of data attributes into an algorithm trained to output a WPS, and outputting the WPS for the customer.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a contact center according to various aspects of the present disclosure.

FIG. 2 is a more detailed block diagram of the contact center of FIG. 1 according to aspects of the present disclosure.

FIG. 3 is simplified block diagram of an embodiment of a contact center, analytics center, and a system for providing a WPS according to various aspects of the present disclosure.

FIG. 4 is a flowchart illustrating a preferred method of providing a WPS according to aspects of the present disclosure.

FIG. 5 is a block diagram of a computer system suitable for implementing one or more components in FIG. 3 according to one embodiment of the present disclosure.

### DETAILED DESCRIPTION OF THE PREFERRED EMBODIMENTS

The present disclosure advantageously corrects for under-reporting, personality-biased reporting, or both, common in NPS® systems by providing a more accurate NPS® (also referred to herein as a modified NPS®). The NPS® for a customer who takes an NPS® survey is corrected for personality bias, and thus an NPS® can now be predicted for a customer who does not take an NPS® survey (typically, one who does not take an NPS® survey related to the topic or communication being evaluated). The NPS® can then be used by a company to better focus its internal actions to improve customer satisfaction and its NPS®. The NPS® can be further be used by companies to take more specific and directed actions to improve customer satisfaction, and data is provided that is actionable on the customer level and at the customer contact level, and optionally also at the group level, rather than only at the group level (e.g., all customers).

The weighted promoter score (WPS) is a score that may be provided by a consumer that indicates how satisfied a consumer is with a service or product. It should be understood that, although the present disclosure focuses on the NPS®, the NPS® is just one example of a weighted promoter score. The term WPS and modified NPS® are thus used interchangeably herein.

The methods include receiving a communication between an agent and a customer, extracting one or more data attributes from the communication, such as personality type of the customer, inputting at least one data attribute into an algorithm trained to output a WPS, and outputting a WPS for the customer. In one embodiment, the communication is a telephonic interaction, and the telephonic interaction is recorded.

Systems and apparatuses for carrying out these methods are also part of the present disclosure. An exemplary system to provide an WPS of a customer includes, for example, a node including a processor and a computer readable medium operably coupled thereto, the computer readable medium including a plurality of instructions stored in association therewith that are accessible to, and executable by, the processor, where the plurality of instructions includes instructions that, when executed, receive a communication between an agent and a customer, determine personality type of the customer, and output an WPS of the customer based on the personality type.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

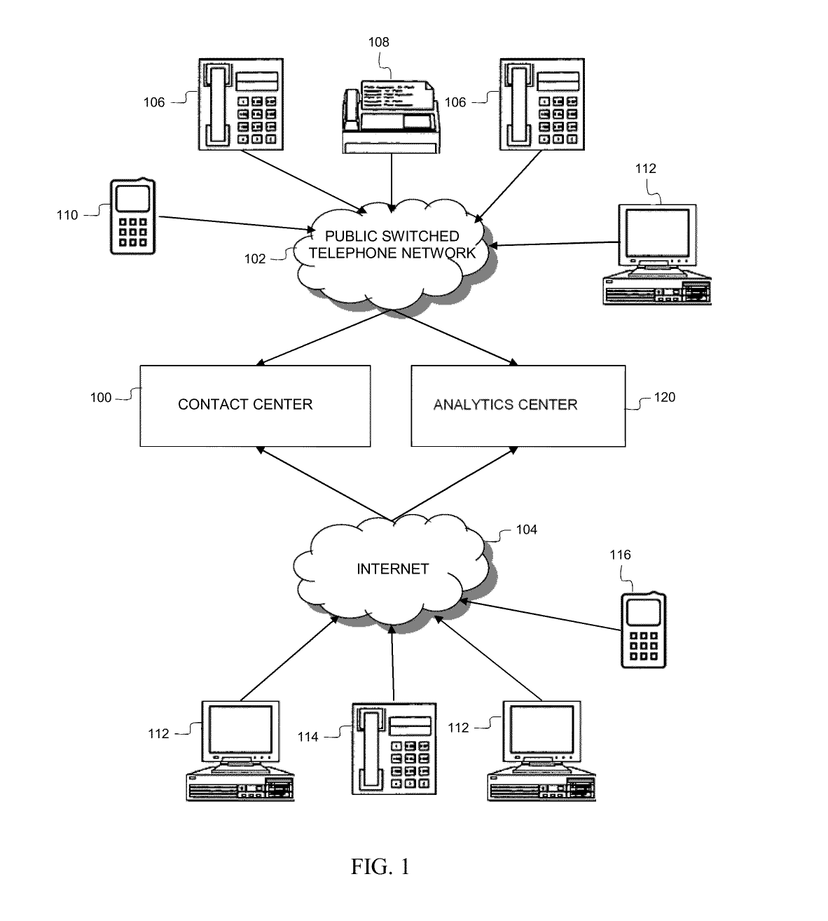

FIG. 1 is a simplified block diagram of an embodiment of a contact center 100 according to various aspects of the present disclosure. A “contact center” as used herein can include any facility or system server suitable for receiving and recording electronic communications from customers. Such customer communications can include, for example, telephone calls, facsimile transmissions, e-mails, web interactions, voice over IP (“VoIP”) and video. Various specific types of communications contemplated through one or more of these channels include, without limitation, email, SMS data (e.g., text), tweet, instant message, web-form submission, smartphone app, social media data, and web content data (including but not limited to internet survey data, blog data, microblog data, discussion forum data, and chat data), etc. In some embodiments, the communications can include customer tasks, such as taking an order, making a sale, responding to a complaint, etc. In various aspects, real-time communication, such as voice, video, or both, is preferably included. It is contemplated that these communications may be transmitted by and through any type of telecommunication device and over any medium suitable for carrying data. For example, the communications may be transmitted by or through telephone lines, cable, or wireless communications. As shown in FIG. 1, the contact center 100 of the present disclosure is adapted to receive and record varying electronic communications and data formats that represent an interaction that may occur between a customer (or caller) and a contact center agent during fulfillment of a customer and agent transaction. In one embodiment, the contact center 100 records all of the customer calls in uncompressed audio formats. In the illustrated embodiment, customers may communicate with agents associated with the contact center 100 via multiple different communication networks such as a public switched telephone network (PSTN) 102 or the Internet 104. For example, a customer may initiate an interaction session through traditional telephones 106, a fax machine 108, a cellular (i.e., mobile) telephone 110, a personal computing device 112 with a modem, or other legacy communication device via the PSTN 102. Further, the contact center 100 may accept internet-based interaction sessions from personal computing devices 112, VoIP telephones 114, and internet-enabled smartphones 116 and personal digital assistants (PDAs).

Often, in contact center environments such as contact center 100, it is desirable to facilitate routing of customer contacts, be it a telephone-based interaction, a web-based interaction, or other type of electronic interaction over the PSTN 102 or Internet 104. Traditionally, limited categories of customer data are used to create predictive models. As a result, such models tend not to be as accurate as possible because of limited data inputs and because of the heterogeneous nature of interaction data collected across multiple different communication channels.

As one of ordinary skill in the art would recognize, the illustrated example of communication channels associated with a contact center 100 in FIG. 1 is just an example, and the contact center may accept customer interactions, and other analyzed interaction information and/or routing recommendations from an analytics center, through various additional and/or different devices and communication channels whether or not expressly described herein.

For example, in some embodiments, internet-based interactions and/or telephone-based interactions may be routed through an analytics center 120 before reaching the contact center 100 or may be routed simultaneously to the contact center 100 and the analytics center 120 (or even directly and only to the contact center 100). In some instances, the analytics center 120 is a third-party analytics company that captures multi-channel interaction data associated with the contact center 100 and applies predictive analytics to the data to generate actionable intelligence for the contact center 100. For example, the analytics center 120 may provide a predicted or corrected NPS® according to the present disclosure, a database module to receive a customer communication and determine the personality type of the customer and a scoring module to correct or predict the NPS® of the customer, or any combination thereof, as well as providing all of the above functionality. Also, in some embodiments, internet-based interactions may be received and handled by a marketing department associated with either the contact center 100 or analytics center 120. The analytics center 120 may be controlled by the same entity or a different entity than the contact center 100. Further, the analytics center 120 may be a part of, or independent of, the contact center 100.

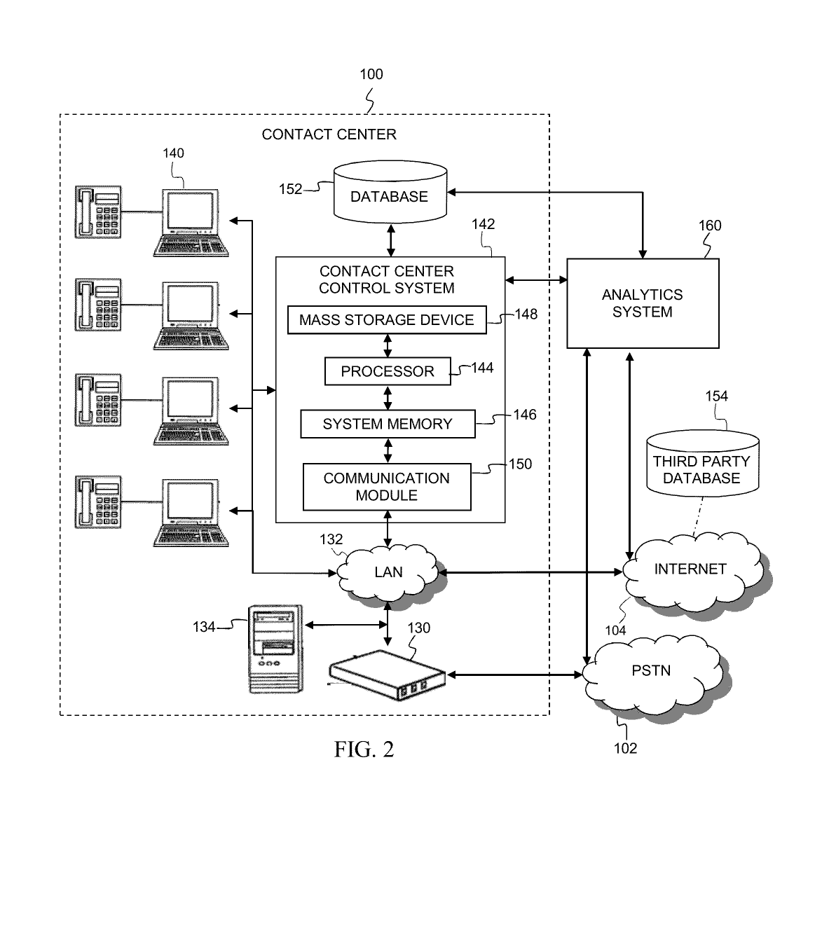

FIG. 2 is a more detailed block diagram of an embodiment of the contact center 100 according to aspects of the present disclosure. As shown in FIG. 2, the contact center 100 is communicatively coupled to the PSTN 102 via a distributed private branch exchange (PBX) switch 130. The PBX switch 130 provides an interface between the PSTN 102 and a local area network (LAN) 132 within the contact center 100. In general, the PBX switch 130 connects trunk and line station interfaces of the PSTN 102 to components communicatively coupled to the LAN 132. The PBX switch 130 may be implemented with hardware or virtually. A hardware-based PBX may be implemented in equipment located local to the user of the PBX system. In contrast, a virtual PBX may be implemented in equipment located at a central telephone service provider that delivers PBX functionality as a service over the PSTN 102. Additionally, in one embodiment, the PBX switch 130 may be controlled by software stored on a telephony server 134 coupled to the PBX switch. In another embodiment, the PBX switch 130 may be integrated within telephony server 134. The telephony server 134 incorporates PBX control software to control the initiation and termination of connections between telephones within the contact center 100 and outside trunk connections to the PSTN 102. In addition, the software may monitor the status of all telephone stations coupled to the LAN 132 and may be capable of responding to telephony events to provide traditional telephone service. In certain embodiments, this may include the control and generation of the conventional signaling tones including without limitation dial tones, busy tones, ring back tones, as well as the connection and termination of media streams between telephones on the LAN 132. Further, the PBX control software may programmatically implement standard PBX functions such as the initiation and termination of telephone calls, either across the network or to outside trunk lines, the ability to put calls on hold, to transfer, park and pick up calls, to conference multiple callers, and to provide caller ID information. Telephony applications such as voice mail and auto attendant may be implemented by application software using the PBX as a network telephony services provider.

In one embodiment, the telephony server 134 includes a trunk interface that utilizes conventional telephony trunk transmission supervision and signaling protocols required to interface with the outside trunk circuits from the PSTN 102. The trunk lines carry various types of telephony signals such as transmission supervision and signaling, audio, fax, or modem data to provide plain old telephone service (POTS). In addition, the trunk lines may carry other communication formats such T1, ISDN or fiber service to provide telephony or multimedia data images, video, text or audio.

The telephony server 134 includes hardware and software components to interface with the LAN 132 of the contact center 100. In one embodiment, the LAN 132 may utilize IP telephony, which integrates audio and video stream control with legacy telephony functions and may be supported through the H.323 protocol. H.323 is an International Telecommunication Union (ITU) telecommunications protocol that defines a standard for providing voice and video services over data networks. H.323 permits users to make point-to-point audio and video phone calls over a local area network. IP telephony systems can be integrated with the public telephone system through an IP/PBX-PSTN gateway, thereby allowing a user to place telephone calls from an enabled computer. For example, a call from an IP telephony client within the contact center 100 to a conventional telephone outside of the contact center would be routed via the LAN 132 to the IP/PBX-PSTN gateway. The IP/PBX-PSTN gateway would then translate the H.323 protocol to conventional telephone protocol and route the call over the PSTN 102 to its destination. Conversely, an incoming call from a customer over the PSTN 102 may be routed to the IP/PBX-PSTN gateway, which translates the conventional telephone protocol to H.323 protocol so that it may be routed to a VoIP-enable phone or computer within the contact center 100.

The contact center 100 is further communicatively coupled to the Internet 104 via hardware and software components within the LAN 132. One of ordinary skill in the art would recognize that the LAN 132 and the connections between the contact center 100 and external networks such as the PSTN 102 and the Internet 104 as illustrated by FIG. 2 have been simplified for the sake of clarity and the contact center may include various additional and/or different software and hardware networking components such as routers, switches, gateways, network bridges, hubs, and legacy telephony equipment.

In various embodiments, the contact center 100 includes a communication distributor that distributes customer communications or tasks to agents. Generally, the communication distributor is part of a switching system designed to receive customer communications and queue them. In addition, the communication distributor distributes communications to agents or specific groups of agents according to a prearranged scheme.

As shown in FIG. 2, the contact center 100 includes a plurality of agent workstations 140 that enable agents employed by the contact center 100 to engage in customer interactions over a plurality of communication channels. In one embodiment, each agent workstation 140 may include at least a telephone and a computer workstation. In other embodiments, each agent workstation 140 may include a computer workstation that provides both computing and telephony functionality. Through the workstations 140, the agents may engage in telephone conversations with the customer, respond to email inquiries, receive faxes, engage in instant message conversations, text (e.g., SMS, MMS), respond to website-based inquires, video chat with a customer, and otherwise participate in various customer interaction sessions across one or more channels including social media postings (e.g., Facebook, LinkedIn, etc.). Further, in some embodiments, the agent workstations 140 may be remotely located from the contact center 100, for example, in another city, state, or country. Alternatively, in some embodiments, an agent may be a software-based application configured to interact in some manner with a customer. An exemplary software-based application as an agent is an online chat program designed to interpret customer inquiries and respond with pre-programmed answers.

The contact center 100 further includes a contact center control system 142 that is generally configured to provide recording, voice analysis, behavioral analysis, storage, and other processing functionality to the contact center 100. In the illustrated embodiment, the contact center control system 142 is an information handling system such as a computer, server, workstation, mainframe computer, or other suitable computing device. In other embodiments, the control system 142 may be a plurality of communicatively coupled computing devices coordinated to provide the above functionality for the contact center 100. The control system 142 includes a processor 144 that is communicatively coupled to a system memory 146, a mass storage device 148, and a communication module 150. The processor 144 can be any custom made or commercially available processor, a central processing unit (CPU), an auxiliary processor among several processors associated with the control system 142, a semiconductor-based microprocessor (in the form of a microchip or chip set), a macroprocessor, a collection of communicatively coupled processors, or any device for executing software instructions. The system memory 146 provides the processor 144 with non-transitory, computer-readable storage to facilitate execution of computer instructions by the processor. Examples of system memory may include random access memory (RAM) devices such as dynamic RAM (DRAM), synchronous DRAM (SDRAM), solid state memory devices, and/or a variety of other memory devices known in the art. Computer programs, instructions, and data, such as known voice prints, may be stored on the mass storage device 148. Examples of mass storage devices may include hard discs, optical disks, magneto-optical discs, solid-state storage devices, tape drives, CD-ROM drives, and/or a variety other mass storage devices known in the art. Further, the mass storage device may be implemented across one or more network-based storage systems, such as a storage area network (SAN). The communication module 150 is operable to receive and transmit contact center-related data between local and remote networked systems and communicate information such as customer interaction recordings between the other components coupled to the LAN 132. Examples of communication modules may include Ethernet cards, 802.11 WiFi devices, cellular data radios, and/or other suitable devices known in the art. The contact center control system 142 may further include any number of additional components, which are omitted for simplicity, such as input and/or output (I/O) devices (or peripherals), buses, dedicated graphics controllers, storage controllers, buffers (caches), and drivers. Further, functionality described in association with the control system 142 may be implemented in software (e.g., computer instructions), hardware (e.g., discrete logic circuits, application specific integrated circuit (ASIC) gates, programmable gate arrays, field programmable gate arrays (FPGAs), etc.), or a combination of hardware and software.

According to one aspect of the present disclosure, the contact center control system 142 is configured to record, collect, and analyze customer voice data and other structured and unstructured data, and other tools may be used in association therewith to increase efficiency and efficacy of the contact center. As an aspect of this, the control system 142 is operable to record unstructured interactions between customers and agents occurring over different communication channels including without limitation telephone conversations, email exchanges, website postings, social media communications, smartphone application (i.e., app) communications, fax messages, texts (e.g., SMS, MMS, etc.), and instant message conversations. For example, the control system 142 may include a hardware or software-based recording server to capture the audio of a standard or VoIP telephone connection established between an agent workstation 140 and an outside customer telephone system. Further, the audio from an unstructured telephone call or video conference session (or any other communication channel involving audio or video, e.g., a Skype call) may be transcribed manually or automatically and stored in association with the original audio or video. In one embodiment, multiple communication channels (i.e., multi-channel) may be used according to the invention, either in real-time to collect information, for evaluation, or both. For example, control system 142 can receive, evaluate, and store telephone calls, emails, and fax messages. Thus, multi-channel can refer to multiple channels of interaction data, or analysis using two or more channels, depending on the context herein.

In addition to unstructured interaction data such as interaction transcriptions, the control system 142 is configured to captured structured data related to customers, agents, and their interactions. For example, in one embodiment, a “cradle-to-grave” recording may be used to record all information related to a particular telephone call from the time the call enters the contact center to the later of: the caller hanging up or the agent completing the transaction. All or a portion of the interactions during the call may be recorded, including interaction with an interactive voice response (IVR) system, time spent on hold, data keyed through the caller's key pad, conversations with the agent, and screens displayed by the agent at his/her station during the transaction. Additionally, structured data associated with interactions with specific customers may be collected and associated with each customer, including without limitation the number and length of calls placed to the contact center, call origination information, reasons for interactions, outcome of interactions, average hold time, agent actions during interactions with customer, manager escalations during calls, types of social media interactions, number of distress events during interactions, survey results, and other interaction information. In addition to collecting interaction data associated with a customer, the control system 142 is also operable to collect biographical profile information specific to a customer including without limitation customer phone number, account/policy numbers, address, employment status, income, gender, race, age, education, nationality, ethnicity, marital status, credit score, customer “value” data (i.e., customer tenure, money spent as customer, etc.), personality type (as determined by past interactions), and other relevant customer identification and biological information. The control system 142 may also collect agent-specific unstructured and structured data including without limitation agent personality type, gender, language skills, performance data (e.g., customer retention rate, etc.), tenure and salary data, training level, average hold time during interactions, manager escalations, agent workstation utilization, and any other agent data relevant to contact center performance. Additionally, one of ordinary skill in the art would recognize that the types of data collected by the contact center control system 142 that are identified above are simply examples and additional and/or different interaction data, customer data, agent data, and telephony data may be collected and processed by the control system 142. All of these types of data may be considered the additional or “other data attributes,” which may be used in creating the modified NPS according to the disclosure.

The control system 142 may store recorded and collected interaction data in a database 152, including customer data and agent data. In certain embodiments, agent data, such as agent scores for dealing with customers, are updated daily.

The control system 142 may store recorded and collected interaction data in a database 152. The database 152 may be any type of reliable storage solution such as a RAID-based storage server, an array of hard disks, a storage area network of interconnected storage devices, an array of tape drives, or some other scalable storage solution located either within the contact center or remotely located (i.e., in the cloud). Further, in other embodiments, the contact center control system 142 may have access not only to data collected within the contact center 100 but also data made available by external sources such as a third party database 154. In certain embodiments, the control system 142 may query the third party database for customer data such as credit reports, past transaction data, and other structured and unstructured data.

Additionally, in some embodiments, an analytics system 160 may also perform some or all of the functionality ascribed to the contact center control system 142 above. For instance, the analytics system 160 may record telephone and internet-based interactions, perform behavioral analyses, predict customer personalities or customer profiles, retrieve pre-existing customer profiles, and perform other contact center-related computing tasks, as well as combinations thereof. The analytics system 160 may be integrated into the contact center control system 142 as a hardware or software module and share its computing resources 144, 146, 148, and 150, or it may be a separate computing system housed, for example, in the analytics center 120 shown in FIG. 1. In the latter case, the analytics system 160 includes its own processor and non-transitory computer-readable storage medium (e.g., system memory, hard drive, etc.) on which to store predictive analytics software and other software instructions.

The multi-channel interaction data collected in the context of the control center 100 may be subject to a linguistic-based psychological behavioral model to assess the personality of customers and agents associated with the interactions. For example, such a behavioral model may be applied to the transcription of a telephone call, instant message conversation, or email thread, between a customer and agent to gain insight into why a specific outcome resulted from the interaction.

In one embodiment, interaction data is mined for behavioral signifiers associated with a linguistic-based psychological behavioral model. In particular, the contact center control system 142 searches for and identifies text-based keywords (i.e., behavioral signifiers) relevant to a predetermined psychological behavioral model. In a preferred embodiment, multi-channels are mined for such behavioral signifiers.

It is well known that certain psychological behavioral models have been developed as tools, and any such behavioral model available to those of ordinary skill in the art will be suitable for use in connection with the disclosure. These models are used to attempt to evaluate and understand how and/or why one person or a group of people interacts with another person or group of people. One example is the Big Five inventory model (© 2000) by UC Berkeley psychologist Oliver D. John, Ph.D. Another is the Process Communication Model™ developed by Dr. Taibi Kahler. Exemplary personality types, which will vary from model to model and can be selected as desired for a given application or across all applications, might include, for example: Thoughts, Opinions, Reactions, and Emotions. These models generally presuppose that all people fall primarily into one of the enumerated basic personality types. In some cases; the models categorize each person as one of these four types (or some other number of personality types), all people have parts of each of the types within them. Each of the types may learn differently, may be motivated differently, may communicate differently, and may have a different sequence of negative behaviors in which they engage under certain circumstances, e.g., when they are in distress. Importantly, each personality type may respond positively or negatively to communications that include tones or messages commonly associated with another of the personality types. Thus, an understanding of a customer's personality type typically offers guidance as to how the customer will react or respond to different situations.

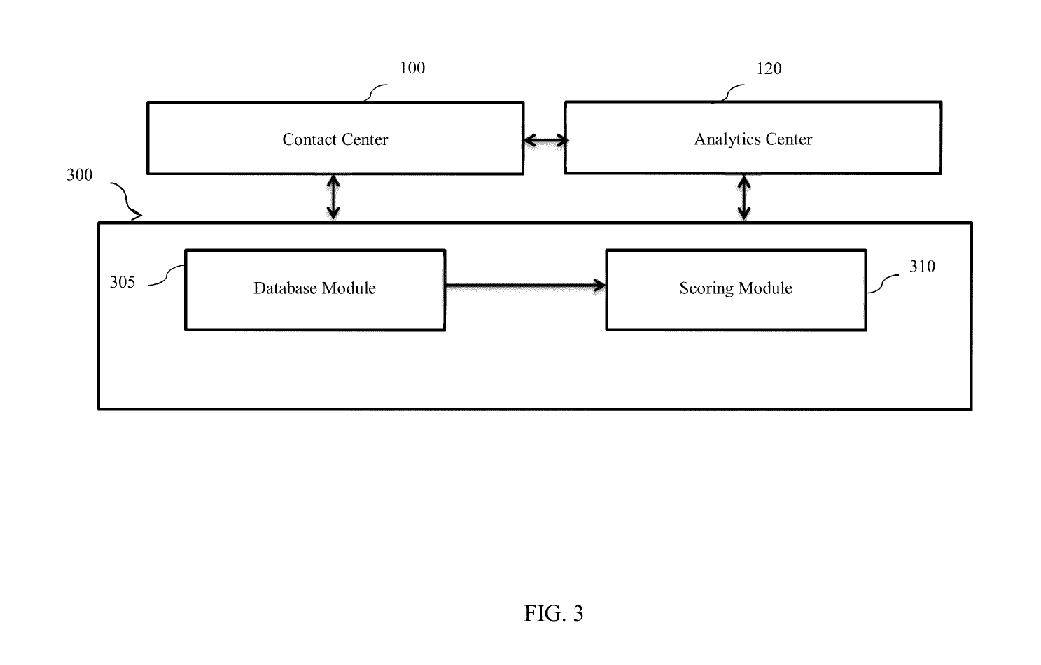

FIG. 3 illustrates an exemplary WPS system 300 operatively associated with contact center 100. In one embodiment, parts or the whole of WPS system 300 is integrated into contact center 100. In another embodiment, parts or the whole of WPS system 300 is operated separately from contact center 100, such as by a processing/analytics company (i.e., in this unshown embodiment, the contact center 100 may be replaced with an analytics center 120 in whole or in part), and WPS system 300 provides a WPS to contact center 100. As shown, WPS system 300 includes database module 305 and scoring module 310.

As shown, database module 305 receives customer communication data from contact center 100. The database module 305 can receive, store and manage large volumes of data. The database module 305, in some embodiments, associates identifying origination data of a customer with a prediction of what the profile (e.g., personality type) the customer is likely to be. Identifying origination data typically includes a contact number or network address, or any combination thereof. The contact number may include at least one of a telephone number, a text message number, short message service (SMS) number, multimedia message service (MMS) number, or a combination thereof. The network address can include at least one of an email address, electronic messaging address, voice over IP address, IP address, social media identifier (e.g., Facebook identifier, Twitter identifier, chat identifier), or a combination thereof. These identifiers are associated with personality types based on the linguistic model.

The database module 305 contains the aggregated summary of scores across the personality types in a linguistic model and can predict which personality type the customer is most likely to be. The aggregated summary of scores weighs certain communications differently to predict the personality type of the customer in one embodiment. For example, if there are multiple calls from a single telephone number, more recent calls are typically given more weight than older calls. Also, the time of day can be taken into account to predict personality type of the customer if more than one personality type is associated with a single telephone number. For example, if the telephone number is associated with an emotions-based customer during the day, and a thoughts-based customer at night, the database module 305 can return a customer personality-type prediction based on that pattern. This might be an indication of a person whose personality is influenced by time of day, or of two different people using that number at different times of day, which can be predicted or determined based on this and other data attributes.

In one embodiment, the prediction of personality type is based on past calls or communications to that contact center and other organizations. For instance, the prediction can be based on previous transactions between the customer and contact center, the answers to menu choices, past purchase history, past calling history, past survey responses, etc. These histories can be general, such as the customer's general history for purchasing products, average contact time with an agent, or average customer satisfaction ratings. This prediction can be created and/or stored in the database module 305 from past interactions with the customer.

In some embodiments, the customer is a repeat customer and already has a customer profile associated with the identifying origination data that was stored. When the database module 305 receives a customer communication, it may retrieve the pre-existing customer profile so that it can be used in the next step. In other embodiments where no customer profile exists or it cannot be readily identified, the database module 305 can predict the incoming customer profile for further use.

The database module 305 is adapted to apply, in one embodiment, linguistic algorithms to the text of the communication and output a personality type. A linguistic algorithm(s) is typically created by linguistic analysts and such algorithm(s) are typically trained using previously analyzed customer-agent communications. In one embodiment, the analyst(s) can review communications and manually label keywords or terms that are relevant to an identified personality type. The algorithm is trained to check for those keywords and the number of times they are used in the communications. A more sophisticated algorithm may be used that additionally checks for use of the keywords in context. One master algorithm containing many specific algorithms may also be used.

In various embodiments, the database module 305 determines or extracts other data attributes from the communication, which in some embodiments is a telephonic communication between customer and agent. Such data attributes include one or more of emotional state (e.g., distress level, life events, engagement, state of mind, distress, empathy, motivation, openness, etc.), in transition or past details (e.g., purpose of contact/task, contact time, likelihood of purchase, likelihood of attrition/account closure, customer satisfaction, etc.) and demographic data (e.g., race, age, education, accent, income, nationality, ethnicity, area code, zip code, marital status, job status, credit score, gender). These data attributes may be determined in substantially the same way as discussed above with respect to personality type. That is, they may be retrieved from a stored customer profile, predicted based on historical data, or determined by applying algorithms (e.g., linguistic algorithms) to text of the communication, or any combination thereof.

In one embodiment, the database module 305 extracts distress level, purpose of contact/task, empathy, engagement, and marital status. In a second embodiment, the database module 305 extracts motivation, life events, likelihood of purchase, customer satisfaction, and gender. In a third embodiment, the database module 305 extracts state of mind, distress, likelihood of attrition/account closure, race, age, and education.

Scoring module 310 uses one or more algorithms that are configured to calculate a WPS based on a data attribute, such as a personality type, and in one embodiment additionally based on one or more other data attributes of the communication. The algorithms are trained using known personality types, data attributes and WPS, and in most embodiments the algorithms are previously trained. The algorithms output a WPS that is corrected for under reporting, personality-based bias, or both.

Under reporting refers to the likelihood of a customer to respond to a survey. A customer is more likely to respond to a survey when the customer has had a very positive or very negative experience, which results in many Promoters and Detractors and few Passives. Thus, there is an “under reporting” of Passives in a conventional NPS®.

Personality-based bias refers to the likelihood of a customer to respond to a survey based on his or her personality type, and the likelihood of certain personality types to give higher or lower scores. For example, if a thoughts caller typically gives scores that are one point higher than all other personality types, the WPS according to the present disclosure maybe corrected to account for that personality type difference.

Both of these issues can skew a company's true NPS®. In various embodiments, the algorithms and models correct for both under reporting and personality-based bias by calculating the true NPS® for every communication that is received, not just the NPS® for customers who actually respond to an NPS® survey. The models correct these problems to produce a modified NPS® according to the present disclosure that allows a company to more accurately and efficiently direct its internal actions to improve its customer satisfaction.

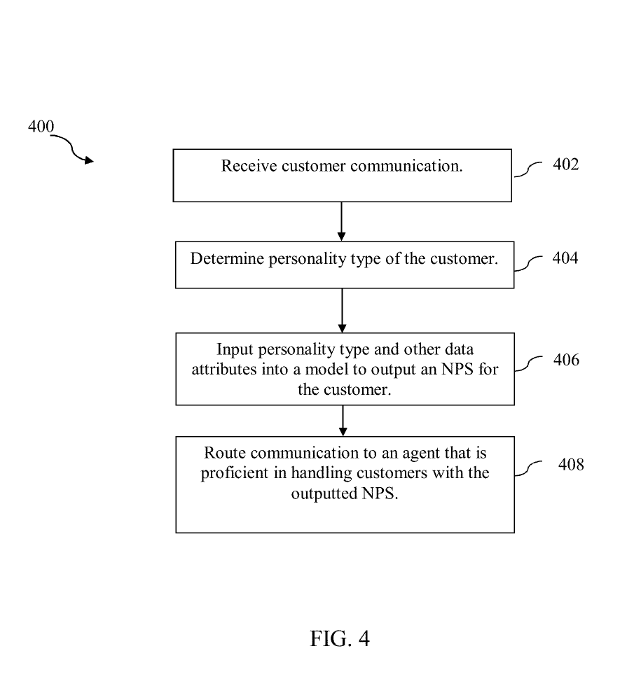

An exemplary method 400 of providing a WPS of a customer will now be described with respect to FIG. 4. At step 402, a customer communication or task is received at contact center 100. Again in FIG. 4, the contact center 100 in one embodiment may be replaced by, or be associated with, an analytics center 120 as seen in FIG. 3. The communication type may include any of the channels discussed herein or available to those of ordinary skill in the art, including without limitation one or more voice calls, voice over IP, facsimiles, emails, web page submissions, internet chat sessions, wireless messages (e.g., text messages such as SMS (short messaging system) messages or paper messages), short message service (SMS), multimedia message service (MMS), or social media (e.g., Facebook identifier, Twitter identifier, etc.), IVR telephone sessions, voicemail messages (including emailed voice attachments), or any combination thereof. In one embodiment, the communication is a telephonic interaction.

At step 404, the database module 305 receives a request from the contact center 100 and determines the personality type of the customer. In one embodiment, the database module 305 predicts the personality type of the customer based on previous transactions between the customer and contact center 100, the answers to menu choices, past purchase history, past calling history, past survey responses, etc. In other embodiments, the database module 305 retrieves the pre-existing customer profile of the customer to determine customer personality type. In yet another embodiment, the text of the communication is analyzed and run through a linguistic algorithm to determine personality type of the customer.

In some embodiments, the database module 305 further extracts other data attributes disclosed herein from the communication, such as (without limitation) one or more of distress level, life events, engagement, state of mind, distress, and purpose of contact/task, demographic data (race, age, education, accent, income, nationality, ethnicity, area code, zip code, marital status, job status, credit score, gender), likelihood of purchase, empathy, motivation, contact time, openness, likelihood of attrition/account closure, customer satisfaction, or a combination thereof.

At step 406, the personality type and other data attributes are input into a model that was previously trained to output a WPS of the customer. The algorithm takes the inputs and outputs a corrected NPS® or predicted NPS® of the customer, i.e., each and collectively, a modified NPS®. The corrected NPS® accounts for personality bias of the customer, and the predicted NPS® (e.g., Promoter or Detractor) accounts for customers who have not taken an NPS® survey.

At step 408, based on the outputted WPS, the communication is routed to an agent. In the depicted embodiment, the agent is proficient in handling customers with the outputted WPS. Based on the customer data, agent data, task type (which may be from IVR), customer data, customer contact events, environmental events, etc., the communication is routed to an agent suited to take the customer communication. Agent data includes, but is not limited to agent performance metrics, tenure, agent personality type analytics scores, and other data about the agent. Customer data includes, but is not limited to, customer ID, personality type, account history with the contact center, customer contact frequency or history (including prior instances of distress), and other relevant available customer attributes.

The routing decisions may be based on comparing one or more customer data and agent data, which may include, e.g., performance based data, demographic data, psychographic data, and other business-relevant data. The skills of the agents are assessed to establish which agent possesses the skills that are most needed for the customer communication. The routing decision may be focused mostly on selection of the most proficient agent for the customer.

In various embodiments, the outputted WPS can be used train agents. Often, in contact center environments such as contact center 100, it is desirable to evaluate communications between an agent and a customer in a customer interaction, be it a telephone-based interaction, a web-based interaction, or other type of electronic interaction over the PSTN 102 or Internet 104. It is also often desirable to train agents to improve the quality of their interactions with customers. Thus, in some embodiments, the present disclosure provides a method for training the agent by analyzing communications between the agent and the customer and the outputted WPS.

In certain embodiments, the WPS is determined for a plurality of customers and aggregated into an overall score for an individual agent, group of agents (e.g., those handling a particular personality type or a specific customer), or for a company. The scores can be aggregated for a predefined period (e.g., 1 month, 2 months, 6 months, one year, etc.) to trace the agent's, group of agents′, or company's, performance over time. The aggregated score for each agent can be compared to the scores for other agents at the same or different contact centers or companies for a given time period. In one embodiment, an agent's score is compared against target scores, and these targets can be adjusted depending on the desired performance. The scores can be provided to the agent (or group of agents) and used as a training aid to improve the agent's (or agents′) performance. The aggregated score for one period can also be directly compared to an aggregated score for the same agent or group of agents (or company) over a different period of time, for a specific agent or a plurality of agents (or company). In various embodiments referring to a company, a group of companies may be used instead, e.g., to compare an agent, group of agents, or company to a group of companies that approximates industry-wide data or averages.

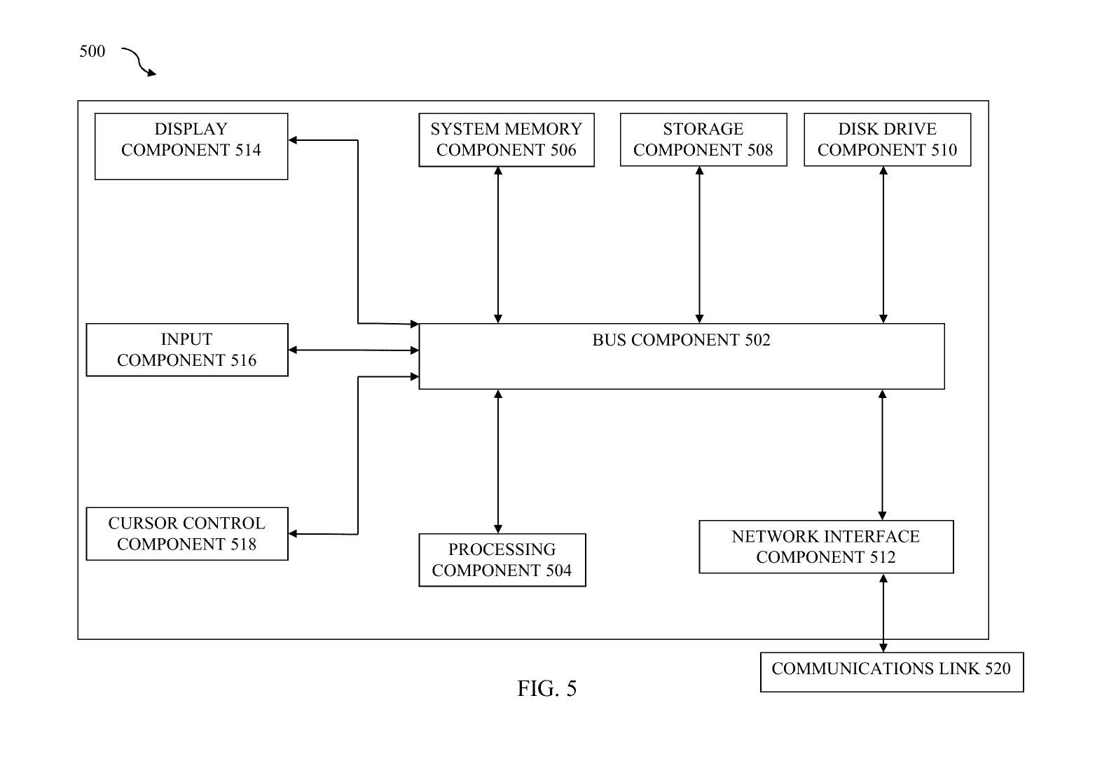

Referring now to FIG. 5, illustrated is a block diagram of a system 500 suitable for implementing embodiments of the present disclosure, including database module 305 and scoring module 310 depicted in FIG. 3. System 500, such as part a computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 512, a display component 514 (or alternatively, an interface to an external display), an input component 516 (e.g., keypad or keyboard), and a cursor control component 518 (e.g., a mouse pad).

In accordance with embodiments of the present disclosure, system 500 performs specific operations by processor 504 executing one or more sequences of one or more instructions contained in system memory component 506. Such instructions may be read into system memory component 506 from another computer readable medium, such as static storage component 508. These may include any instructions disclosed herein, including to determine a customer personality type, output an NPS of the customer based on the personality type, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., networks 102 or 104 of FIG. 1, LAN, WLAN, PTSN, or various other wired or wireless networks) may perform instruction sequences to practice the disclosure in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

In view of the present disclosure, it will be appreciated that various methods and systems have been described according to one or more embodiments for providing an NPS of a customer.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow a quick determination of the nature of the technical disclosure. It is submitted with the understanding that it will not be used to interpret or limit the scope or meaning of the claims.

1. A system for providing a weighted promoter score (WPS), comprising:
a node comprising a processor and a non-transitory computer readable medium operably coupled thereto, the non-transitory computer readable medium comprising a plurality of instructions stored in association therewith that are accessible to, and executable by, the processor, where the plurality of instructions comprises:
instructions that, when executed, receive a communication between an agent and a customer;
instructions that, when executed, determine personality type of the customer; and
instructions that, when executed, output a WPS of the customer based on the personality type.

2. The system of claim 1, wherein the customer has not taken a WPS survey related to the communication.

3. The system of claim 1, further comprising instructions that, when executed, use at least one other data attribute of the communication as additional input with the personality type to output the WPS of the customer.

4. The system of claim 3, wherein the other data attributes comprise distress level, life events, engagement, state of mind, distress, and purpose of contact/task, demographic data, likelihood of purchase, empathy, motivation, contact time, openness, likelihood of attrition/account closure, customer satisfaction, or any combination thereof.

5. The system of claim 1, further comprising instructions that, when executed, aggregate outputted WPSs for one or more individual agents, one or more companies, or any combination thereof.

6. The system of claim 1, further comprising instructions that, when executed, route the communication to an agent proficient in handling customers with the outputted WPS.

7. The system of claim 1, further comprising instructions that, when executed, train an agent using the outputted WPS.

8. A method for providing a weighted promoter score (WPS) of a customer, which comprises:
receiving, by one or more processors, a communication between an agent and a customer;
extracting, by one or more processors, a data attribute from the communication, including personality type of the customer;
inputting, by one or more processors, the personality type into an algorithm trained to output a WPS; and
outputting a WPS for the customer.

9. The method of claim 8, wherein the customer has not taken a WPS survey related to the communication.

10. The method of claim 8, which further comprises inputting at least one other data attribute into the algorithm to output the WPS of the customer.

11. The method of claim 9, wherein the other data attributes comprise distress level, life events, engagement, state of mind, distress, and purpose of contact/task, demographic data, likelihood of purchase, empathy, motivation, contact time, openness, likelihood of attrition/account closure, customer satisfaction, or any combination thereof.

12. The method of claim 8, which further comprises aggregating a plurality of outputted WPSs for one or more individual agents, one or more companies, or any combination thereof.

13. The method of claim 8, which further comprises routing the communication to an agent proficient in handling customers with the outputted WPS.

14. The method of claim 8, which further comprises training an agent using the outputted WPS.

15. A non-transitory computer readable medium comprising a plurality of instructions comprising:
instructions that, when executed, receive a communication between an agent and a customer;
instructions that, when executed, retrieve or predict the personality type of the customer;
instructions that, when executed, extract a data attribute from the communication; and
instructions that, when executed, output a weighted promoter score (WPS) of the customer based on the personality type and other data attributes of the communication.

16. The non-transitory computer readable medium of claim 15, wherein the customer has not taken a WPS survey related to the communication.

17. The non-transitory computer readable medium of claim 15, wherein the data attribute comprises distress level, life events, engagement, state of mind, distress, and purpose of contact/task, demographic data, likelihood of purchase, empathy, motivation, contact time, openness, likelihood of attrition/account closure, customer satisfaction, or any combination thereof.

18. The non-transitory computer readable medium of claim 15, further comprising instructions that, when executed, aggregate outputted WPS for one or more individual agents, one or more companies, or any combination thereof.

19. The non-transitory computer readable medium of claim 15, further comprising instructions that, when executed, route the communication to an agent proficient in handling customers with the outputted WPS.

20. The non-transitory computer readable medium of claim 15, further comprising instruction that, when executed, train an agent using the outputted WPS.

21. The non-transitory computer readable medium of claim 15 wherein the instructions that, when executed retrieve or predict the personality type of the customer are configured to apply a linguistic-based psychological behavioral model to the communication.

22. A method for providing a weighted promoter score (WPS) of a customer, which comprises:
recording, by one or more processors, a telephonic interaction between an agent and a customer;
extracting, by one or more processors, a plurality of data attributes, including personality type of the customer, from the telephonic interaction;
inputting, by one or more processors, the plurality of data attributes into an algorithm trained to output a WPS; and
outputting, by one or more processors, the WPS for the customer.

23. The method of claim 22, wherein the plurality of data attributes relate to emotional state, in transition or past details, demographic data, or a combination thereof.

24. The method of claim 23, wherein the plurality of data attributes that relate to emotional state comprises distress level, life events, engagement, state of mind, distress, empathy, motivation, openness, or a combination thereof; the plurality of data attributes that relate to in transition or past details comprises purpose of contact/task, contact time, likelihood of purchase, likelihood of attrition/account closure, customer satisfaction, or a combination thereof; and the plurality of data attributes that related to demographic data comprise race, age, education, accent, income, nationality, ethnicity, area code, zip code, marital status, job status, credit score, gender, or a combination thereof.

25. The method of claim 22, which further comprises aggregating a plurality of outputted WPSs for one or more individual agents, one or more companies, or any combination thereof.

26. The method of claim 22, which further comprises routing the communication to an agent proficient in handling customers predicted to a matching type of WPS.

27. The method of claim 22, which further comprises training an agent using one or more outputted WPS values.

28. The system of claim 1, wherein the instructions that, when executed, determine personality type of the customer are configured to apply a linguistic algorithm to the communication.

29. The method of claim 8, wherein the personality type inputted into an algorithm is determined by applying a linguistic algorithm to the communication.

30. The method of claim 22, wherein the extracting, by one or more processors, of a plurality of data attributes, including personality type of the customer, from the telephonic interaction is configured to apply a linguistic algorithm to the communication.
